(19) United States
(12) Patent Application Publication
(10) Pub. No.: US 2015/0273412 A1
(43) Pub. Date: Oct. 1, 2015

(54) FLUID TREATMENT MANIFOLD FOR FLUID STORED IN TANKS

(71) Applicant: APACHE CORPORATION, Houston, TX (US)

(72) Inventor: Grant Defosse, Calgary (CA)

(73) Assignee: APACHE CORPORATION, HOUSTON, TX (US)

(21) Appl. No.: 14/434,749

(22) PCT Filed: Nov. 12, 2013
(86) PCT No.: PCT/US13/69534

§ 371 Date: Apr. 9, 2015

Related U.S. Application Data
(60) Provisional application No. 61/728,177, filed on Nov. 19, 2012.

(51) Int. Cl. B01F 5/10

(52) U.S. Cl. CPC B01F 5/10

(57) ABSTRACT

A stored fluid treatment manifold includes a frame and a fluid transfer conduit extending from proximate one end of the frame to the other end of the frame. The fluid transfer conduit has a T outlet conduit coupled thereto proximate one end thereof and a T inlet conduit coupled thereto such that the T inlet conduit is disposed above the surface of stored fluid in a tank when the frame is disposed in the tank.

### BACKGROUND

This disclosure relates generally to the field of fluid treatment where fluids are stored in tanks More specifically, the disclosure relates to devices for initiating and maintain circulation of fluid in such tanks, wherein energy for the circulation is provided by pumped in treatment fluid.

Fluids, such as water produced from subsurface wellbores, may be stored in tanks such as above ground cylindrically walled structures lined with an impermeable barrier that is resistant to degradation by the fluid stored in the tank. It is sometimes necessary to provide chemical treatment to the stored fluid in order to prevent contamination or degradation of the stored fluid before it is pumped from the tank to its ultimate use or disposal.

It is known in the art to pump treatment fluid into the stored fluid using hoses having an outlet weighted to remain at the bottom of the tank. This is known as “rolling” the tank. Such known techniques may require movement of the hose outlet in order to ensure that the treatment fluid is adequately dispersed through the stored fluid. Such movement can be time consuming and require intervention of a human operator in order to be performed successfully. Often this operation damages the impermeable liner.

There is a need for improved techniques and devices for pumping treatment fluid in to fluid stored in tanks to reduce the amount of human operator intervention and to improve dispersion of the treatment fluid within the stored fluid.

### SUMMARY

One aspect of the disclosure is a stored fluid treatment manifold includes a frame and a fluid transfer conduit extending from proximate one end of the frame to the other end of the frame. The fluid transfer conduit has a T outlet conduit coupled thereto proximate one end thereof and a T inlet conduit coupled thereto such that the T inlet conduit is disposed above the surface of stored fluid in a tank when the frame is disposed in the tank.

Other aspects and advantages will be apparent from the description and claims which follow.

### BRIEF DESCRIPTION OF THE DRAWINGS

FIG. 1 shows example above ground storage tanks

FIG. 2 shows an example fluid fill and drain manifold that may be used in connection with the example tanks shown in FIG. 1.

FIGS. 3 and 4 show opposed oblique views of an example fluid treatment manifold in accordance with the present disclosure.

FIG. 5 shows the example manifold of FIG. 4 disposed in fluid in a tank.

### DETAILED DESCRIPTION

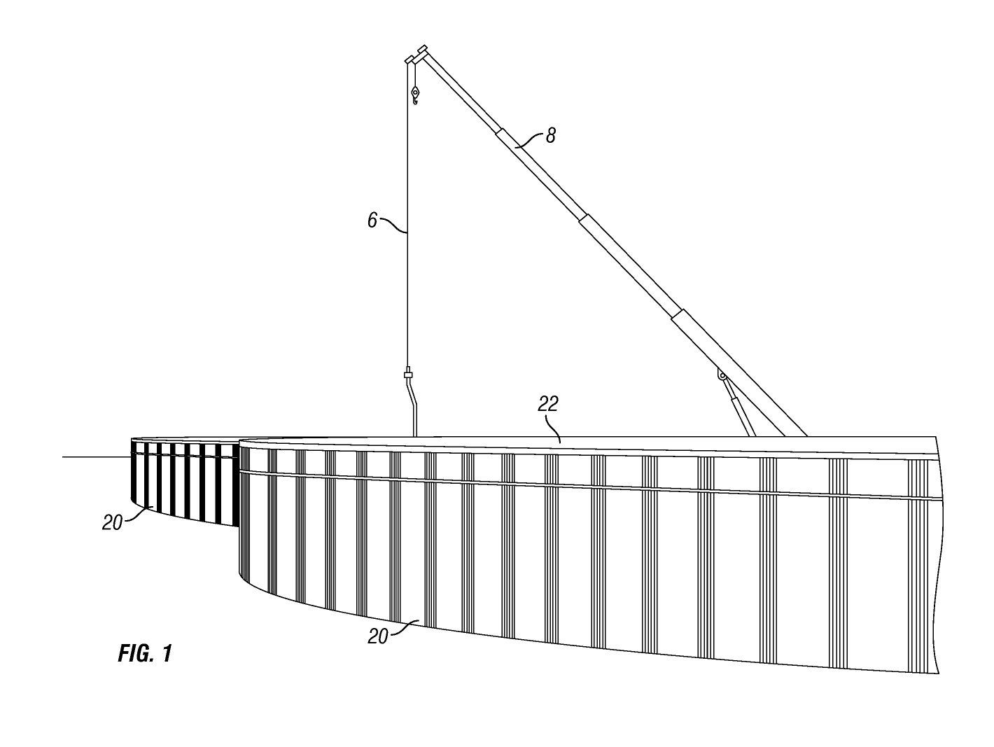

FIG. 1 shows an example of fluid storage tanks 20 that may be used with some example embodiments of a fluid treatment manifold according to the present disclosure. The present example fluid storage tanks 20 may include a substantially cylindrical wall lined with an impermeable barrier 22, such as polyethylene or similar material. The example fluid storage tanks 20 in FIG. 1 may be readily transported from one location to another; however it should be clearly understood that other forms of storage tanks, such as pits dug into the ground surface, or site constructed containers that are essentially immobile, may also be used with a treatment manifold in accordance with the present disclosure. The fluid storage tanks 20 are intended to store fluid of any type. In the present example, the fluid storage tanks 20 may store water produced from subsurface formations through wellbores (not shown) drilled therethrough for such purpose.

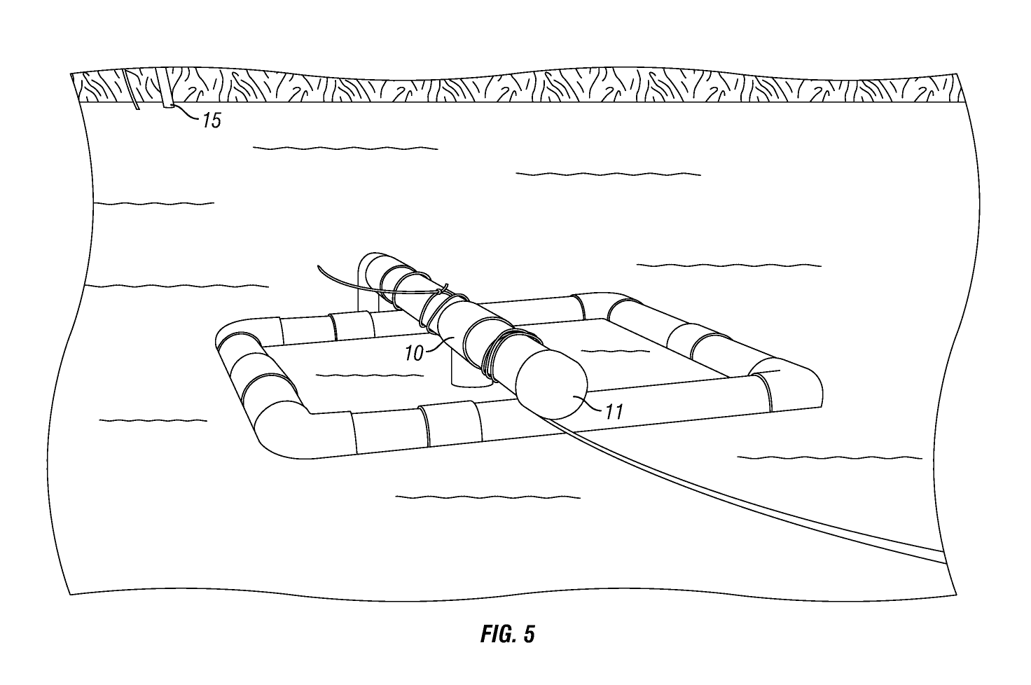

FIG. 1 also shows a crane 8 with a lift line 6 extending therefrom which may be coupled to a treatment manifold to move the treatment manifold within a fluid storage tank 20 as will be explained below with reference to FIG. 5.

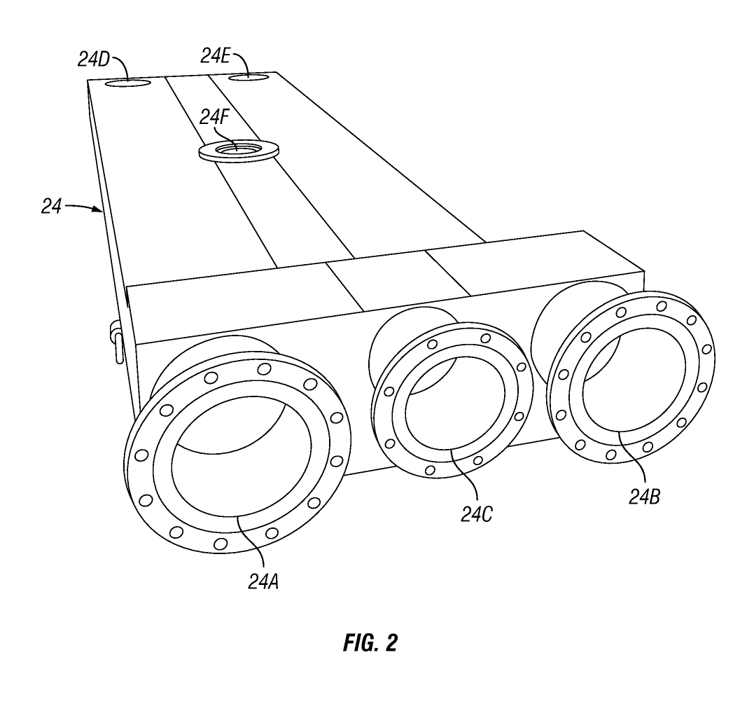

FIG. 2 shows an example fill and drain manifold 24 that may be disposed at the bottom of a fluid storage tank such as shown at 20 in FIG. 1. The fill and drain manifold 24 may be made from a dense material. The fill and drain manifold 24 may include a fluid inlet fitting 24A, a fluid outlet fitting 24B and a fluid pump through fitting 24C, for pumping fluid to “spin” the fluid in the storage tank (20 in FIG. 1) for skimming or treating operations. The fill and drain manifold 24 includes a fluid opening 24D, 24E, 24F to the interior of the fluid storage tank (20 in FIG. 1) corresponding to each fitting 24A, 24B, 24C. Fluid to be pumped into a fluid storage tank (20 in FIG. 1) may enter the fill and drain manifold 24 through the fluid inlet fitting 24A and be discharged into the fluid storage tank (20 in FIG. 1) through the corresponding fluid opening 24D. Fluid may be removed from the fluid storage tank (20 in FIG. 1) by pumping fluid outwardly from the outlet fitting 24B, which fluid will be withdrawn therefrom through the corresponding fluid opening 24E. The pump through fitting 24C and corresponding fluid opening 24F may be used as described for “rolling” the fluid stored in the tank. Each of the inlet fitting 24A, outlet fitting 24B and pump through fitting 24C may have suitable conduits such as pipes or hoses (not shown in the drawings for clarity) connected thereto for movement of fluid into and out of the fluid storage tank (20 in FIG. 1) as explained above.

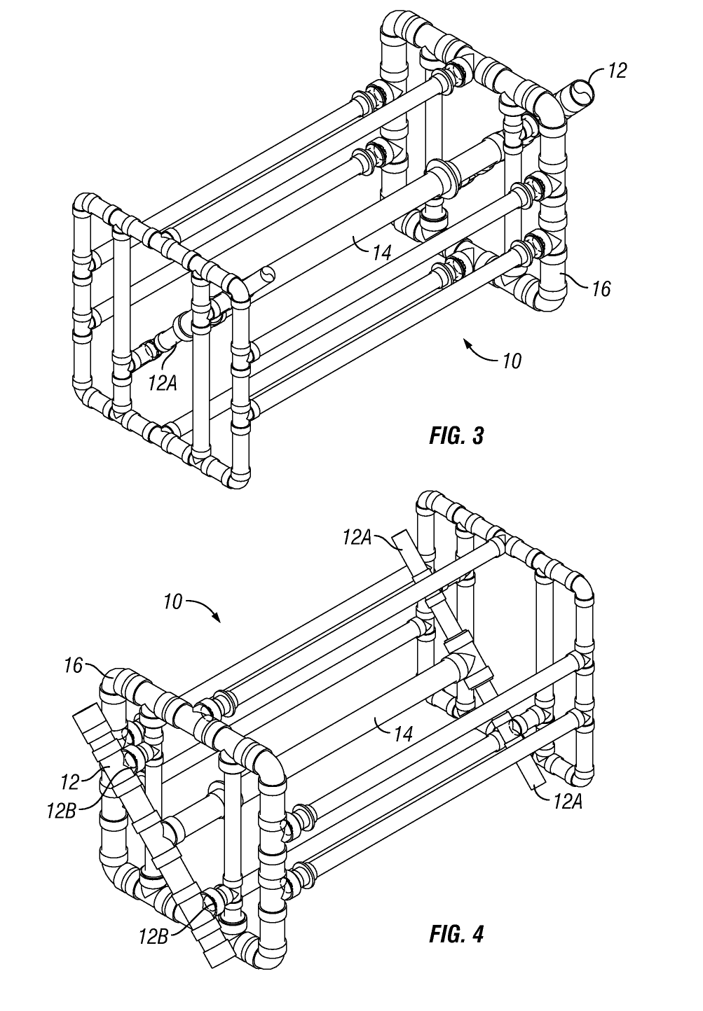

FIGS. 3 and 4 show opposed, oblique views of a fluid treatment manifold according to the present disclosure. The fluid treatment manifold 10 may include a generally box-shaped manifold frame 16, which may be assembled from segments of conduit, such as may be made from polyvinyl chloride (PVC) or other material. The material from which the manifold frame 16 is made should be resistant to chemical reaction with or degradation caused by the treatment chemical to be pumped into the stored fluid through the fluid treatment manifold 10 as well as the fluid disposed in the fluid storage tank (20 in FIG. 1). The material from which the manifold frame 16 may be made from a material having a density selected and dimensions (e.g., tube diameter and tube length) selected such that a volume of air trapped inside the manifold frame 16 will provide the manifold frame 16 and conduits coupled thereto, as explained below, with overall positive buoyancy when disposed in the fluid in the fluid storage tank (20 in FIG. 1).

The manifold frame 16 may include coupled thereto a fluid transfer conduit 14.

The fluid transfer conduit 14 may have at one longitudinal end an inlet “T” conduit 12. The inlet “T” conduit 12 may include couplings 12B that are closed to fluid flow to couple the inlet “T” conduit 12 and the fluid transfer conduit 14 to the manifold frame 16. The inlet “T” conduit 12 may be coupled to a source of treatment fluid at either or both ends of the “T” as will be shown in FIG. 5. The inlet “T” conduit 12 may be disposed, and the length of the transfer conduit 14 selected based on the depth of the fluid in the storage tank (20 in FIG. 1). An outlet “T” conduit 12A may be connected to the opposite end of the fluid transfer conduit 14. The length of the fluid transfer conduit 14 may also be selected such that the outlet “T” conduit 12A may be disposed longitudinally inside the end of the manifold frame 16.

In some examples, the end of the manifold frame 16 proximate the outlet “T” conduit 12A may be weighted, or may be filled with a weighting material more dense than the stored fluid so that the manifold frame 16 will self-orient in a direction so that its longitudinal dimension is substantially vertical and the end of the manifold frame 16 proximate the inlet “T” conduit 12 may be caused to float near the surface of the liquid in the fluid storage tank (20 in FIG. 1). The inlet “T” conduit 12 may be exposed above the fluid surface within the fluid storage tank (20 in FIG. 1) for relatively easy access (as may be observed in FIG. 5). When the manifold frame 16 is so oriented and floats within the stored fluid, the outlet “T” conduit 12A will be disposed at a selected depth below the surface of the stored fluid in the fluid storage tank (20 in FIG. 1).

The outlet “T” conduit 12A may be open at both its longitudinal ends so that treatment fluid pumped into the fluid treatment manifold 10 (through the fluid inlet “T” conduit 12) may result in a fluid circulation being established within the stored fluid in the fluid storage tank (20 in FIG. 1) to assist in dispersing the treatment fluid within the stored fluid. The inlet “T” conduit 12 may be connected to a source of the treatment fluid at one or both ends. If connected at only one end, the opposite “T” end of the inlet “T” conduit 12 may be closed with a cap, valve or the like. An example cap is shown at 11 in FIG. 5.

FIG. 5 shows the example fluid treatment manifold 10 as explained with reference to FIGS. 3 and 4 disposed in stored fluid in a fluid storage tank (e.g., such as shown at 20 in FIG. 1). As shown in FIG. 5, a source of treatment fluid may be provided through a hose 15 or similar conduit to one end of the inlet “T” conduit (12 in FIG. 3) wherein the inlet “T” conduit is disposed above the stored fluid surface. The other end of the inlet “T” conduit 12 may be closed with a cap 11 as described above. If and as necessary, the fluid treatment manifold 10 may be moved within the fluid storage tank (20 in FIG. 1) to enable complete treatment of substantially all the volume of fluid stored in the fluid storage tank. Because part of the fluid treatment manifold 10 may remain above the stored fluid level, it may be possible to remove connection of a device (e.g., crane 8 and line 6 shown in FIG. 1) used to move the fluid treatment manifold during times when the fluid treatment manifold 10 is not being moved, such that the foregoing device may be used for other purposes.

In one example, the treatment fluid may be chlorine dioxide, and as previously explained, the stored fluid may be produced water from subsurface formations. It should be understood that the foregoing is only one example of stored fluid and treatment fluid that may be used in accordance with the present disclosure. The type of treatment fluid and the type of stored fluid are not limitations on the scope of the present disclosure.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A stored fluid treatment manifold, comprising:
a frame; and
a fluid transfer conduit extending from proximate one end of the frame to proximate the other end of the frame, the fluid transfer conduit having a T outlet conduit coupled thereto proximate one end thereof and a T inlet conduit coupled thereto such that the T inlet conduit is disposed above the surface of stored fluid in a tank when the frame is disposed in the tank.

2. The manifold of claim 1 wherein both ends of the T outlet conduit are open to fluid movement.

3. The manifold of claim 1 wherein an end of the frame proximate the T outlet conduit is weighted such that the frame self orients in a substantially vertical longitudinal orientation when suspended in stored fluid wherein the T inlet conduit is disposed upwardly of the T outlet conduit.

4. The manifold of claim 1 wherein the frame comprises polyvinyl chloride tubing.
